(19) United States
(12) Patent Application Publication
(10) Pub. No.: US 2011/0070480 A1
(43) Pub. Date: Mar. 24, 2011

(54) THREE-DIMENSIONAL MICROBATTERY AND METHOD FOR THE PRODUCTION THEREOF

(75) Inventors: Robert Hahn, Berlin (DE); Thomas Wohrle, Stuttgart-Feuerbach (DE); Calin Wurm, Ellwangen (DE)

(73) Assignee: Fraunhofer-Gesellschaft zur Forderung der Angewandten Forschung E.V., Munchen (DE)

(21) Appl. No.: 12/919,539

(22) PCT Filed: Feb. 25, 2009
(86) PCT No.: PCT/EP2009/001584

§ 371 Date: Dec. 6, 2010

(30) Foreign Application Priority Data
Feb. 26, 2008 (DE) 102008011523.1

(51) Int. Cl. H01M 10/02; H01M 10/04; H01M 6/46

(52) U.S. Cl. 429/162; 29/623.5

(57) ABSTRACT

A three-dimensional microbattery is disclosed, in which a depression, in which two chambers lying adjacent to one another in the substrate plane are implemented, is provided in a substrate. The active mass, which is impregnated with an electrolyte, of negative and positive electrodes is received in each of the chambers. A porous partition wall, which is impregnated with the electrolyte and prevents a passage of active electrode mass, is located between the two chambers. The free surfaces of the active mass of both electrodes and the partition wall lie in a plane with the surface of the substrate. The electrodes and the partition wall are hermetically sealed by a cover layer, which projects beyond the edge of the depression.

The present invention relates to a three-dimensional microbattery according to the preamble of claim 1 and a method for the production thereof.

For various applications such as self-sufficient energy microsystems, miniaturised radio sensors, active RFID tags, medical implants, Smartcards™ and others, it is desirable to use a battery with the smallest possible dimensions.

For the production of batteries with dimensions in the millimetre range, there have been to date the following possibilities:

Very small round cell batteries. Because of the large proportion of the metal casing and the sealing of the entire system, the energy density is however low. Due to the round construction, the volume in the microsystem is exploited poorly. For contacting, soldering tags or spring contacts are required, which in turn increase the dimensions.

Very small cylindrical cells with a metal casing and glass leadthrough. Here, as in the case of the round cell batteries, integration and contacting is difficult. The batteries are very stable over a long period of time because of the hermetic seal, however are expensive because of the complex production.

Very small prismatic batteries which are disposed between the current collectors by a polymer by means of lamination or adhesion technology or have been packed in a sealed foil (pouch). Since the seal edge must be at least approx. 2 mm, the miniaturisation and the energy density are however restricted.

Thin-film batteries in which the entire layer construction is produced by vacuum coating. In this process, the maximum possible layer thicknesses of the active electrodes are limited to approx. 20 μm since otherwise the mechanical stresses become too large. Since the deposition must be effected on a substrate and encapsulation is also necessary, the total thickness of which is greater than the thickness of the active materials, a low total energy density is produced. Because of the inorganic solid ion conductor, the batteries have high temperature stability. The power rating is also high. Because of the complex and lengthy vacuum process, the cost expenditure is however very high.

In order to achieve higher energy density with the thin-film process, a three-dimensional construction is proposed in US 2006/0154141 A1. For this purpose, firstly a whole-surface inorganic electrolyte layer is provided with cavities which are then filled with the active electrodes and current collectors. Anode and cathode are thereby situated adjacently. In theory, a high energy density can thus be achieved. The main disadvantage hereby is that it concerns thin-film and deposition processes which are very complex. The three-dimensional construction is only sensible if the height of the structure is greater than with a sequential deposition of anode, electrolyte and cathode one above the other. A solid ion conductor with a thickness of substantially more than approx. 20 μm is however difficult to produce. In addition, the ion conductivity is achieved only in Z-direction perpendicular to the substrate because of the microstructure forming during the deposition. In the case of a three-dimensional construction, an ion conductivity parallel to the substrate is however required since anode (negative electrode) and cathode (positive electrode) are situated adjacently. In addition, the lithium ion conductivity of the known solid ion conductors is very low at room temperature.

In U.S. Pat. No. 6,495,283 A, the possibility is described of using a three-dimensionally structured substrate which can also be a three-dimensionally structured current collector or a three-dimensionally structured electrode (cathode) on which then the other layers are deposited. The greatest difficulty with this method could reside in depositing a three-dimensional electrode which ensures good coverage of vertical or steep edges and, at the same time, has good layer thickness constancy with good ionic conductivity at the same time.

Starting from U.S. Pat. No. 6,495,283 A, it is therefore the object of the present invention to produce a three-dimensional microbattery having a substrate which comprises, in a depression, two chambers which are situated adjacently in the substrate plane and in which respectively the active masses of negative and positive electrode and an electrolyte are received, a porous partition wall which is saturated with the electrolyte and prevents passage of active electrode mass being disposed between the two chambers, said partition wall having a high energy density and being able to be adapted or integrated in the dimensions to the respective application. Furthermore, it is intended to be producible in an economical manner.

This object is achieved according to the invention by a three-dimensional microbattery having the features of claim 1. Advantageous developments of this microbattery and also a method for the production thereof are revealed in the sub-claims.

As a result of the fact that the free surfaces of the active mass of both electrodes and of the partition wall are situated in one plane with a surface of the substrate and the electrodes and the partition wall are hermetically sealed by a cover layer projecting beyond the edge of the depressions, a microbattery of high mechanical integrity and considerable energy density is produced.

A method for the production of this microbattery preferably comprises the steps:

formation of a depression in the substrate with simultaneous or subsequent formation of a porous partition wall perpendicular to the substrate surface containing the depression for forming two chambers in the depression,

production of the current collectors for the electrodes in the two chambers,

pouring active mass for the positive and the negative electrode respectively into one of the chambers of the depression,

pouring a liquid electrolyte into the depression,

gelification of the electrolyte, and

hermetic sealing of the depression.

This method enables production of the porous partition wall, of the necessary insulations, electrical leadthroughs and current collectors before the active battery components are added. As a result, high temperature and vacuum processes, wet processes (galvanics), photolithographical processes and the like can implemented, which otherwise are not compatible with the active battery materials. High productivity is obtained if the active masses are applied on the substrate simultaneously for many (preferably a few thousand) microbatteries, for example by screen printing, template printing, dispersing, spraying or in other ways. After gelification of the electrolyte, merely a cover or a hermetic coating which is compatible with the battery materials need be applied. As a result of the fact that polymer electrolytes can be used, a high ionic conductivity and hence power rating is possible, the dimensions and hence the capacity being able to be varied within wide limits. Electrode materials which are used also for larger batteries can be used. By gelification of the electrolyte, vacuum processes can be implemented for the hermetic sealing.

The invention is explained subsequently in more detail with reference to embodiments represented in the Figures. There are shown:

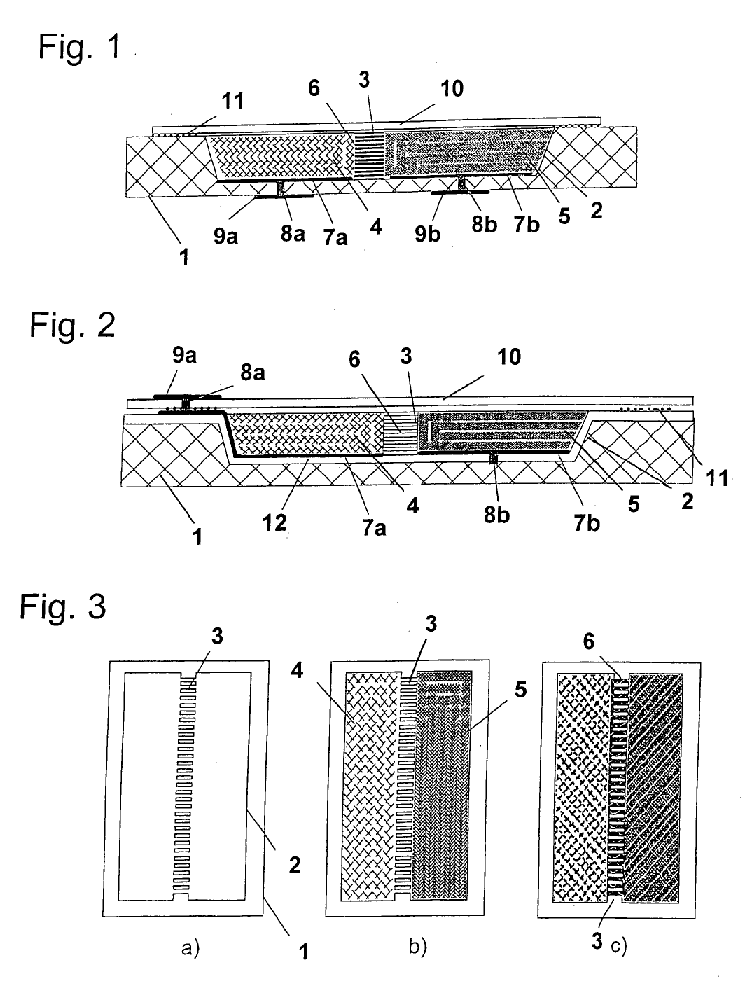

FIG. 1 a microbattery in cross-section with an insulating substrate,

FIG. 2 a microbattery in cross-section with a metallic substrate,

FIG. 3 a production method for a microbattery in three successive steps,

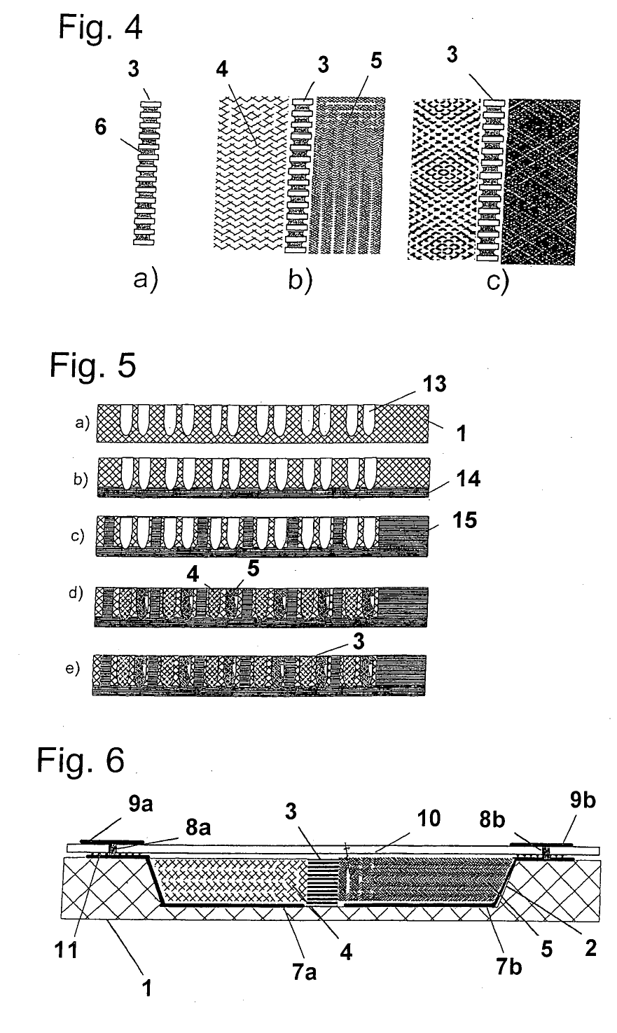

FIG. 4 another production method for a microbattery in three successive steps,

FIG. 5 a further production method for a microbattery in five successive steps, and

FIG. 6 a microbattery in cross-section having an insulating substrate and a contacting on the upper side.

The microbattery according to FIG. 1 contains, in an insulating substrate 1, a depression 2 which has in the centre a porous partition wall 3 extending perpendicular to the drawing plane. In the region to the left of the partition wall 3, the depression 2 is filled with anode mass 4 in order to form the one electrode (anode) and, in the region to the right of the partition wall 3, the depression 2 is filled with cathode material 5 in order to form the other electrode (cathode). Furthermore, the anode- and the cathode material and also the partition wall 3 are completely saturated with gelified electrolyte 6. At the bottom of the depression 2 there are situated, below the anode 4 or the cathode 5 respectively, a current collector 7a or 7b which are connected respectively via an electrical leadthrough 8a or 8b to an external contact 9a or 9b on the underside of the substrate 1. The upper surfaces of the substrate 1, of the anode 4, of the partition wall 3 and of the cathode 5 form a flat and as smooth as possible a surface so that the microbattery can be sealed with a flat cover 10. A suitable connection material 11 surrounding the depression 2 between the cover 10 and the substrate 1 effects a hermetic seal of the depression 2.

Production of this microbattery is effected such that firstly the depression 2 in the substrate 1 is produced. At the same time as production of the depression 2 or subsequently thereto, the porous partition wall 3 is formed. Hereafter, the electrical leadthroughs 8a, 8b, the current collectors 7a, 7b and the external contacts 9a, 9b are produced in the anode- and in the cathode region. Then the anode- and cathode materials 4 and 5 are poured into the depression 2 and these and also the partition wall 3 are subsequently saturated with the liquid electrolyte 6 which is subsequently gelified. Finally, the cover 10 is applied and, as a result, the microbattery is hermetically sealed.

Preferably, glass, silicon, or ceramic material can be used as substrate. The described method enables simultaneous production of a large number of microbatteries in the same substrate. A common cover 10 for all microbatteries in the substrate 1 can be applied. Also the subsequent shaping and testing of the batteries in the composite can also take place. Subsequently, the batteries are separated.

It is important that the surface to be covered is as smooth and flat as possible in order that only a thin adhesive joint is obtained when glueing on the cover. The microbattery according to FIG. 2 differs from the one shown in FIG. 1 essentially in that an electrically conducting, metallic substrate is used. This makes electrical insulation of the microbattery relative to the substrate 1 by means of an insulating layer 12 necessary. This can consist for example of a polymer, such as polychlorinated biphenyl (PCB) or polyimide (PI) or it can also be a glass-like or ceramic layer. An electrical leadthrough 8b through the insulating layer 12 connects the current collector 7b and the substrate 1 so that the substrate 1 can be used as electrical terminal of the cathode 5. For the contacting of the anode 4, the associated current collector 7a is guided out beyond the edge of the depression 2 and an electrical leadthrough 8a through the cover 10 connects it to the external contact 9a applied on the outside of the cover 10.

FIG. 3 shows a method for the production of the microbattery in three steps. The substrate 1 which is used consists of silicon. The depression 2 and the porosity of the partition wall 3 are produced by an etching process. It is important that the partition wall 3 has great porosity and a good opening parallel to the substrate plane. The partition wall 3 shown in FIG. 3a) consists of webs situated closely next to each other. The spacings between the webs are so small that, when pouring the anode- or cathode material into the depression 2, no particles can pass from these into the slots between the webs. The slots can be produced in common with the production of the depression 2, for example by reactive ion etching. FIG. 3b) shows the state after the anode material 4 is poured into the left chamber and the cathode material 5 into the right chamber of the depression 2. The slots in the partition wall 3 are free of electrode material.

FIG. 3c) shows the state after the liquid electrolyte 6 has been poured into the depression 2. The electrolyte 6 saturates the electrode material and fills the slots in the partition wall 6 before it is gelified.

It is evident from FIG. 3 that the microbattery preferably has a rectangular configuration in plan view, the lateral edges parallel to the partition wall 3 being longer than the lateral edges perpendicular thereto. It is consequently achieved that the paths of the ions through the electrodes 4, 5 and the partition wall 3 are as short as possible.

In the method represented in FIG. 4, after production of the depression 2 and the partition wall 3, the liquid electrolyte 6 is firstly introduced only into the slots of the partition wall 3, for example by microdispersion. The electrolyte is retained in these slots by surface tension, as FIG. 4a) shows. Subsequently, the electrolyte 6 is gelified by a thermal process. Then the anode material 4 and the cathode material 5 are introduced into the respective chamber of the depression 2 (FIG. 4b)). These materials can be very fine-particle since passage of these is prevented by the gelified electrolyte 6 in the slots. Subsequently, in a second step of the supply of liquid electrolyte 6, the electrode material 4, 5 is saturated with the latter. Thereafter, this was also gelified, the structure shown in FIG. 4c) is obtained, which is identical to that shown in FIG. 3c).

When using a substrate made of glass or ceramic material, the microporous webs in the partition wall can be produced in a similar manner to the production of filters. The chambers of the depression are produced by etching or laser ablation or a closed substrate and a substrate which has a frame structure are connected to each other. However, it is also possible to start with a completely porous substrate in which depressions are produced by laser machining and subsequently sealing of the electrode tubs externally is effected by coating. FIG. 5 shows such a method in which a plurality of microbatteries are produced in the substrate 1 at the same time.

According to FIG. 5a), blind holes 13 with a high aspect ratio are produced in the penetrably porous glass or ceramic substrate 1 by means of laser ablation or in another manner. Respectively two blind holes 13 which are closely adjacent are used for formation of a microbattery. As FIG. 5b) shows, the lower region of the substrate 1 is subsequently sealed from the underside with a material 14 in that the pores of the substrate 1 are filled with this material which has defined wetting in the porous substrate 1 and is compatible with the electrode materials. The sealing material 14 extends from the underside of the substrate 1 up to the bottom of the blind holes 13.

By means of a material 15 which has the same sealing properties as the material 14 but can be dispensed or printed, the insulation regions between the individual microbatteries, i.e. the arrangements comprising respectively two blind holes 13, are then coated and hence the porosity of the substrate material in these regions is eliminated. Since the material 14 supplied from below and the material 15 supplied from above mutually touch, completely impermeable battery tubs, as shown in FIG. 5c), are produced.

The coating of the internal walls of the blind holes 13 with the current collector is not represented. This can be effected in the known manner by screen printing, template printing, dispensing, thin-film coating, lithography or the like. In the case of ceramic substrates, thick-film processes above all are possible. These layers can also be fired together with the sealing materials 14 and 15. Very stable, reliable layers are produced in this way. Subsequently, the electrode materials 4, 5 are poured in (FIG. 5d)). The batteries finally become functional by introducing the liquid electrolyte 6 into the individual battery tubs in which it saturates the electrode material 4, 5 and also the partition wall 3 which has remained between the blind holes 13 of a battery and is made of the porous substrate material, and subsequent thermal gelification of the electrolyte (FIG. 5e)).

Instead of using substrate material for the partition wall, also porous separator membranes made of other materials can be used. Such membranes generally based on polyolefins can be inserted into the cells without pre-treatment.

FIG. 6 shows a cross-section through a microbattery with an insulating substrate 1, in which, in contrast to the microbattery illustrated in FIG. 1, the external contacts 9a, 9b are situated on the upper side. Both current collectors 7a, 7b are guided respectively outwards beyond the edge of the depression 2 and are connected to an electrical leadthrough 8a or 8b through the cover 10 which, for its part, is connected to the external contact 9a or 9b. The leadthroughs 8a and 8b are situated respectively in the connection region 11, however they can also be disposed outwith the latter.

Instead of the cover 10, foils can also be laminated onto the battery structure for the hermetic sealing or encapsulation can be effected by layer deposition. For example, parylenes can be applied and also, for better sealing, a layer composite comprising insulator- and metal layers. If the electrical contacts are guided out towards the upper side, the leadthroughs are produced by structuring by means of laser or lithography and etching.

The external dimensions of the microbattery according to the invention should be between 0.1 and 20 mm, preferably between 0.4 and 5 mm. Their thickness should be between 5 and 500 μm, preferably between 50 and 200 μm. The thickness of the partition wall 3 should be in the range between 1 and 1000 μm, preferably between 10 and 100 μm. The anode-(negative electrode) and the cathode region (positive electrode) should have respectively a width between 0.01 and 5 mm, advantageously between 0.1 and 2 mm, and a length between 0.1 and 20 mm, advantageously between 1 and 10 mm. The specific capacity of the microbattery should be between 0.5 and 4 mAh/cm².

There should be mentioned as examples of active electrode materials in rechargeable lithium-ion cells, for the anode, MCMB (fully synthetic graphite) and also various natural graphites, for the cathode, LiCoO₂ (lithium-cobalt oxide) and, for the binder, PVDF-HFP-Co polymer and also PVDF homopolymer. There are suitable as gel electrolytes, EC+PC+LiPF₆ and also (EC)+GBL+LiBF₄.

Alternative anode materials are Li-titanate (Li₄Ti₅O₁₂), Li₂₂Si₅, LiA₁, Li₂₂Sn₅, Li₃Sb, and LiWO₂, and also alternative cathode materials, LiNiO₂, LiMn₂O₄, LiNi_{0.8}Co_{0.2}O₂, lithium iron phosphate (LiFePO₄) and nanostructured materials.

Of interest above all are materials with a long lifespan and cycle stability since the microbattery is integrated and, during the entire lifespan of the respective device, is intended to function as a buffer. A high pulse-current loading (C rate) is also of importance.

In principle, also aqueous battery systems are possible and also primary batteries. There is mentioned as an example of this, a system of the flat cell LFP25. The construction principle is a 3V system in which metallic lithium (anode) as opposed to manganese dioxide (MnO₂) is used as cathode. An electrolyte based on lithium perchlorate (LiClO₄) serves as electrolyte.

The field of application of the microbattery according to the invention is electrical current supply for microsystems, in particular for self-sufficient energy microsystems, intermediate memories for miniaturised radio sensors, intermediate memories for energy harvesting devices, i.e. self-sufficient energy systems which draw their energy from the environment, active RFID tags, medical implants, wearable computing, backup battery in microsystems, chip cards, memory chips, systems in packages, systems on chip, miniaturised data loggers and also intelligent munitions.

What is claimed is:

1. A three-dimensional microbattery having a substrate, the microbattery comprising:
a depression in the substrate, the depression including,
two chambers which are situated adjacently in the substrate and in which respectively an active mass of a negative and a positive electrode and an electrolyte are received, and
a porous partition wall which is saturated with the electrolyte and prevents passage of the active mass being disposed between the two chambers,
wherein a free surface of the active mass of both electrodes and of the partition wall are situated in one plane with a surface of the substrate and the electrodes and the partition wall are hermetically sealed by a cover layer projecting beyond an edge of the depression.

2. The microbattery according to claim 1, wherein the partition wall consists of a same material as the substrate.

3. The microbattery according to claim 1, wherein the depression has a rectangular shape in a plan view with a set of longer lateral edges parallel to the partition wall.

4. The microbattery according to claim 1, wherein one or more leadthroughs are provided in the substrate and/or in the cover layer for receiving current collectors for the electrodes.

5. The microbattery according to claim 1, wherein the substrate consists of electrically insulating material and contains at least one leadthrough for the contacting of one of the electrodes.

6. The microbattery according to claim 1, wherein the substrate consists of electrically conducting material and a layer made of insulating material disposed between the substrate and the active mass.

7. The microbattery according to claim 6, further including an electrical connection between at least one of the electrodes electrode and an underside surface of the substrate is provided.

8. A method for the production of a three-dimensional microbattery, the microbattery including
a depression in the substrate, the depression including,
two chambers which are situated adjacently in the substrate and in which respectively an active mass of a negative and a positive electrode and an electrolyte are received, and
a porous partition wall which is saturated with the electrolyte and prevents passage of the active mass being disposed between the two chambers,
wherein a free surface of the active mass of both electrodes and of the partition wall are situated in one plane with a surface of the substrate and the electrodes and the partition wall are hermetically sealed by a cover layer projecting beyond an edge of the depression;
the method comprising:
formation of a depression in a substrate with simultaneous or subsequent formation of a porous partition wall perpendicular to a substrate surface containing the depression for forming two chambers in the depression,
production of the current collectors for the electrodes in the chambers,
pouring active mass for the positive and the negative electrode respectively into one of the chambers of the depression,
pouring a liquid electrolyte into the depression,
gelification of the electrolyte, and
hermetic sealing of the depression.

9. The method according to claim 8, wherein, before the active mass is poured in, an electrical connection between at least one of the current collectors and the substrate surface situated opposite the substrate surface containing the depression is produced through the substrate.

10. The method according to claim 8, wherein a plurality of microbatteries is produced simultaneously in the same substrate.

11. The method according to claim 8, wherein, when using a metallic substrate, the internal surface of the depression is provided with an insulating layer before production of the current collectors.

12. The method according to claim 11, wherein, before the active mass is poured in, an electrical connection between one of the current collectors and the substrate is produced through the insulating layer.

13. The method according to claim 8, wherein, when using a silicon substrate, simultaneous formation of the depression and of the porous partition wall is effected by reactive ion etching.

14. The method according to claim 13, wherein, before the active mass is poured in, a part of the electrolyte is introduced into the partition wall and gelified.

15. The method according to claim 8, wherein, when using a porous substrate, the depression is formed by sealing filling of the pores of the substrate in the region surrounding the microbattery and, within the depression, the two chambers are formed by removing the substrate material.

16. The method according to claim 8, wherein the partition wall is inserted after forming a continuous depression made of a different material from the substrate material.
